(19) United States
(12) Patent Application Publication
(10) Pub. No.: US 2025/0104413 A1
(43) Pub. Date: Mar. 27, 2025

(54) Method of shoplifting detection from surveillance camera using artificial intelligence technology

(71) Applicant: VIETTEL GROUP, Ha Noi City (VN)

(72) Inventors: Thi Hanh Vu, Hai Phong City (VN); Thi Hanh Le, Yen Son District (VN)

(73) Assignee: VIETTEL GROUP, Ha Noi City (VN)

(21) Appl. No.: 18/890,934

(22) Filed: Sep. 20, 2024

(30) Foreign Application Priority Data
Sep. 22, 2023 (VN) 1-2023-06531

(51) Int. Cl. G06V 10/82; G06V 10/62; G06V 20/52; G06V 40/20

(52) U.S. Cl. CPC G06V 10/82; G06V 10/62; G06V 20/52; G06V 40/20

(57) ABSTRACT

The invention proposes the method of shoplifting detection from surveillance camera using artificial intelligence technology. This method consists of the following steps: (1) data preprocessing to create short videos from the input video stream, and feed into the deep learning model in step 2; (2) person feature extraction and shoplifting behavior probability calculation using a hybid deep learning model which combines a three-dimensional convolutional neural network (3D-CNN) and a two-dimensional convolutional neural network (2D-CNN) together to learn the spatial-temporal features and the positions of people in the keyframe of processed videos in step 1; (3) post-processing and warning the shoplifting behavior if it occurs.

### TECHNICAL FIELD

The invention refers to the method of shoplifting detection from surveillance cameras. Specifically, the method mentioned in the invention uses artificial intelligence technology and is applied in intelligence video surveillance systems to support social security management.

### BACKGROUND OF THE INVENTION

The fact that Vietnamese stores/supermarkets are regularly facing shoplifting problem, causing loss of revenue and affecting social security.

To prevent this problem, many stores/supermarkets have increased surveillance cameras to observe and quickly detect the shoplifters. However, the monitoring is not automated but is done directly by human observation. Basically, the system can save data, and the administrator can review data to find the shoplifter. Manually monitoring from plenty of cameras takes a lot of human effort and can miss many important events.

Therefore, automatically detection and warning of shoplifting behavior is essential, especially for the screening of a large amount of data from many surveillance cameras every day to reduce human monitoring efforts. In addition, it helps to make the management process of stores/supermarkets become more modern and smarter, minimizing the risks caused by shoplifting.

### BRIEF DESCRIPTION OF METHOD

The purpose of the invention is to propose a method to detect shoplifting behavior via video to apply to security surveillance system with high accuracy and optimal processing speed.

Specifically, the mentioned method comprises the following steps:

Step 1: data preprocessing; the input of this step is the video stream transmitted from the cameras, then it is cut into 1-second clips with sliding window step of 0.5 seconds. Then, these 1-second clips are processed to be the input of the model in the following step.

Step 2: person feature extraction and shoplifting behavior probability calculation; firstly, a hybid deep learning model which combines a three-dimensional convolutional neural network (3D-CNN) and a two-dimensional convolutional neural network (2D-CNN) is used to learn the spatial-temporal features and the positions of people in the keyframe of the 1-second clip processed in step 1, then the probability of shoplifting behavior of each person in the keyframe is computed and the position of them is determined.

Step 3: post-processing and warning; in this step, the probability of shoplifting behavior in entire video is aggregated based on the probability of 1-second clips computed in step 2, thereby giving a warning of the shoplifter if any.

### BRIEF DESCRIPTION OF THE DRAWINGS

FIG. 1 describes the steps in the method of shoplifting detection from surveillance camera.

FIG. 2 describes the components of the hybrid deep learning model which includes a 3D-CNN and a 2D-CNN in step 2.

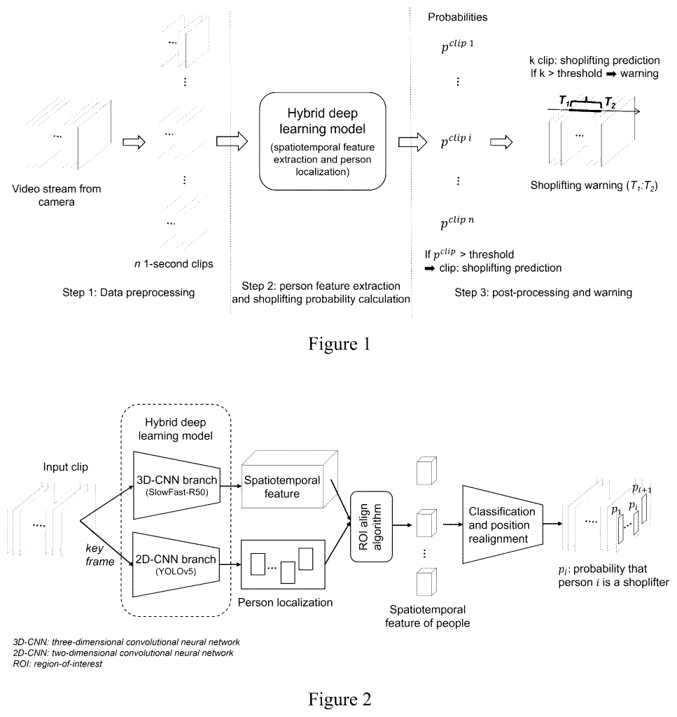

### DETAILED DESCRIPTION

The proposed method is described in detail below with reference to the drawings, which are intended to illustrate the embodiments and are not intended to limit the scope of claims.

In this description of the invention, the terms of “Yolov5”, “SlowFast”, “ACAR-Net”, “ROI Align” are proper nouns, which are the name of the model, algorithm or dataset.

In detail, the a method mentioned in this invention includes the following steps:
Step 1: data preprocessing;
The purpose of this step is pre-preprocessing the input video stream from surveillance camera to feed into the deep learning model in step 2.

The video stream is cut into 1-second clips, these videos are presented at the same playback rate of 25 frames per second (FPS). Therefore, each video segment includes 25 frames with the sliding window is 0.5 seconds corresponding to 12 frames. In addition, the video stream from surveillance camera is often high resolution (HD, Full HD, 2K, etc.), so it is necessary to downsample and resize the frames to reduce inference costs, increase computational speed, and reduce memory storage. Specifically, 12 frames are sampled from 25 frames according to a uniform distribution. After that, the frames are resized to 640×640×3 and normalized to a normal distribution N(0, 1) to be the input of the deep learning model in step 2.

Step 2: person feature extraction and shoplifting behavior probability calculation;
The purpose of this step is to extract the spatio-temporal features of each person in the keyframe of each 1-second clip processed in step 1.

The input of this step is the sequence of frames processed in step 1, which is fed into a hybird deep learning model consisting of a 3D-CNN and a 2D-CNN.

In fact, some simple actions can be detected using a single image (e.g., running, walking, jumping, etc.); however, shoplifting behavior is more complicated, requiring tracking the person over a period of time and observing action in detail. Therefore, to detect this behavior, it is necessary to analyze both the spatial domain (all people in each frame) and the temporal domain (actions of each person across all frames). Because of that, it is inefficient to use only 2D-CNN to classify the frame as usual in image recognition problems. The invention provides a hybrid deep learning model including both 3D-CNN and 2D-CNN architectures. A 3D-CNN model can extract spatiotemporal features by using an additional convolutional dimension to capture temporal information. However, the shoplifting event only takes place in a small area compared to the entire frame in the surveillance camera, so it is difficult for the 3D-CNN model to focus on detecting an action in such a small area. That is why this invention proposes to use a combination of a 2D-CNN model for person localization, thereby helping the 3D-CNN model only focus on the area containing the people for analysis.

The hybrid deep learning model in this invention is built based on the idea of ACAR-Net. The original ACAR-Net model is designed to localize all people in an input video and predict their actions. It has quite a large and complex structure, so real-time deployment may not be feasible. The hybrid model proposed in this invention is simplified compared to the original ACAR-Net, which consists of two parallel main branches. In particular, the first branch is a 3D-CNN model, which is SlowFast-R50. Its input is an entire 1-second clip segment, and it extracts spatiotemporal features of all frames. The second branch is a 2D-CNN model, which is Yolov5. It returns the position of each person in the frame. With these two branches, this hybrid model is optimized while still achieving high accuracy. Next, the spatiotemporal (3-dimensional) features and position of each person from these two branches are combined using the region-of-interest (ROI) align algorithm, and the output is spatiotemporal features of all people. After that, these features are fed into a fully connected layer to classify the actions of each person in the keyframe, and the output is the probability of shoplifting behavior for each person in keyframe. Finally, the shoplifting behavior probability in entire video segment is the highest probability among all the people in the keyframe. The bounding boxes of all people are also realigned to match each other in the output video.

Step 3: post-processing and warning;
The purpose of this step is to determine the shoplifting event that occurred in video stream from surveillance camera. The post-processing and warning (if any) are performed every 5 seconds.

The input of this step is the probability of shoplifting behavior occurring in each 1-second clip from step 2, denoting this probability as p^{clip}. If p^{clip}≥θ, θ is a threshold, then the 1-second clip is predicted to exist shoplifting behavior. Based on experiments, the threshold of θ=0.8 achieves the best prediction accuracy. Because the sliding window of 1-second clip segment is 0.5 seconds, to be sure about the prediction result, the number of 1-second clips with probability p^{clip}≥θ is counted and aggregated (n times). When n≥k (k is another threshold), the system will alert that shoplifting behavior is occurring. Based on experiments, k=3 gives optimal result; however, k can be considered as a threshold parameter that can be adjusted by the system's users. This helps to reduce the influence of signal noise and reduce the inaccurate impact on the final result if the model mispredicts a few keyframes leading to an incorrect prediction of a 1-second clip.

Although the descriptions above contain many specific details, they are not to be considered as limited scope for our claims, but only for the purpose of illustrating some example embodiments.

1. Method of shoplifting detection from surveillance camera using artificial intelligence technology includes the following steps:
step 1: data preprocessing;
an input of this step is a video stream transmitted from the surveillance camera, then it is cut into 1-second clips with sliding window step of 0.5 seconds; then, these 1-second clips are processed to be an input of a model in the following step;
step 2: person feature extraction and shoplifting behavior probability calculation;
firstly, a hybid deep learning model which combines a three-dimensional convolutional neural network (3D-CNN) and a two-dimensional convolutional neural network (2D-CNN) is used to learn spatial-temporal features and positions of people in a keyframe of the 1-second clip processed in step 1, then a probability of shoplifting behavior of each person in the keyframe is computed and a position of them is determined;
step 3: post-processing and warning
in this step, the probability of shoplifting behavior in entire video is aggregated based on the probability of 1-second clips computed in step 2, thereby giving a warning of the shoplifter if any.

2. The method of shoplifting detection from surveillance camera using artificial intelligence technology of claim 1, wherein:
in step 1, the video stream from surveillance camera is cut into 1-second clips, then these 1-second clips are presented at the same playback rate of 25 frames per second (FPS); therefore, each video segment includes 25 frames with the sliding window is 0.5 seconds corresponding to 12 frames; in addition, the video stream from surveillance camera is often high resolution (HD, Full HD, 2K, etc.), so it is necessary to downsample and resize the frames to reduce inference costs, increase computational speed, and reduce memory storage; specifically, 12 frames are sampled from 25 frames according to a uniform distribution; after that, the frames are resized to 640×640×3 and normalized to a normal distribution N(0, 1) to be the input of the deep learning model in step 2.

3. The method of shoplifting detection from surveillance camera using artificial intelligence technology of claim 1, wherein:
in step 2, the input of this step is the sequence of frames processed in step 1, which is fed into a hybird deep learning model consisting of two parallel main branches; the first branch is a 3D-CNN model, which is SlowFast-R50; its input is entire 1-second clip segment, and it extracts spatiotemporal features of all frames; the second branch is a 2D-CNN model, which is Yolov5; it returns the position of each person in the frame; next, the spatiotemporal (3-dimensional) features and position of each person from these two branches are combined using the region-of-interest (ROI) align algorithm, and the output is spatiotemporal features of all people; after that, these features are fed into a fully connected layer to classify the actions of each person in the keyframe, and the output is the probability of shoplifting behavior for each person in keyframe; finally, the shoplifting behavior probability in entire video segment is the highest probability among all the people in the keyframe; the bounding boxes of all people are also realigned to match each other in the output video.

4. The method of shoplifting detection from surveillance camera using artificial intelligence technology of claim 1, wherein:
in step 3, with the video stream transmitted from the surveillance camera, the post-processing and warning (if any) are performed every 5 seconds; the input of this step is the probability of shoplifting behavior occurring in each 1-second clip from step 2, denoting this probability as p^{clip}; if p^{clip}≥θ, θ is a threshold, then the 1-second clip is predicted to exist shoplifting behavior; based on experiments, the threshold of θ=0.8 achieves the best prediction accuracy; because the sliding window of 1-second clip segment is 0.5 seconds, to be sure about the prediction result, the number of 1-second clips with probability p^{clip}≥θ is counted and aggregated (n times); when n≥k (k is another threshold), the system will alert that shoplifting behavior is occurring; based on experiments, k=3 gives optimal result; however, k can be considered as a threshold parameter that can be adjusted by the system's users.
